(19) United States
(12) Patent Application Publication
(10) Pub. No.: US 2023/0333332 A1
(43) Pub. Date: Oct. 19, 2023

(54) OPTICAL RECEIVING ASSEMBLY, METHOD FOR CONTROLLING THE SAME, AND OPTICAL MODULE

(71) Applicant: InnoLight Technology (Suzhou) Ltd., Suzhou (CN)

(72) Inventors: Wenkai TU, Jiangsu (CN); Yuzhou SUN, Jiangsu (CN); Liang LUO, Jiangsu (CN)

(21) Appl. No.: 18/214,116

(22) Filed: Jun. 26, 2023

Related U.S. Application Data
(63) Continuation of application No. PCT/CN2021/133438, filed on Nov. 26, 2021.

(30) Foreign Application Priority Data
Jan. 4, 2021 (CN) 202110002495.1

(51) Int. Cl. G02B 6/42

(52) U.S. Cl. CPC G02B 6/4214; G02B 6/4206; G02B 6/4271; G02B 6/4286

(57) ABSTRACT

An optical receiving assembly, a method for controlling the same, and an optical module are provided. The optical receiving assembly includes an optical receiving port, an adjustable optical path deflection assembly, a semiconductor optical amplifier, an optical detector, and a controller. An optical signal received by the optical receiving port is incident onto the semiconductor optical amplifier after a deflection angle of the optical signal is adjusted. The semiconductor optical amplifier amplifies and couples the incident optical signal to the optical detector, which converts the received optical signal into an electrical signal for output. The controller controls the adjustable optical path deflection assembly to adjust the deflection angle according to the changes of the electrical signal strength, so as to adjust a coupling efficiency of the optical signal coupled to the semiconductor optical amplifier and maintain the electrical signal output by the optical detector within a preset range.

### CROSS-REFERENCE TO RELATED PATENT APPLICATION

This application is a continuation application of International Patent Application Ser. No. PCT/CN2021/133438, filed on Nov. 26, 2021, which the international application was published on Jul. 7, 2022, as International Publication No. WO 2022/142911A1, and claims the priority of China Patent Application No. 202110002495.1, filed on Jan. 4, 2021, in People's Republic of China. The entirety of each of the above patent applications is hereby incorporated by reference herein and made a part of this specification.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to the technical field of optical commination technology, and more particularly to an optical receiving assembly, a method for controlling the same, and an optical module.

### BACKGROUND OF THE DISCLOSURE

Long-distance transmission has long been an important but difficult challenge in the field of optical communication. The use of an avalanche photodiode (APD) can properly extend a transmission distance, but is only suitable for below 40 km. The application of coherent technology allows for transmission of longer distances, but the cost is too high. In actual use, signal attenuation is serious after an optical signal is transmitted over a long distance, and an optical receiver may not be able to detect the optical signal with severe attenuation due to the sensitivity limitation. In order to detect the optical signal with severe attenuation, the optical signal is usually amplified by an optical amplifier before being transmitted to the optical receiver, so that the optical receiver can detect the optical signal. For the optical amplifier, a semiconductor optical amplifier (SOA) is generally used to amplify the incident optical signal. When the incident optical signal is excessively large, the SOA will enter a gain saturation state, which will affect the quality of the amplified optical signal. Therefore, it is necessary to ensure that the incident light is smaller than its gain saturation point, while sufficient sensitivity is also provided. For this purpose, a variable optical attenuator (VOA) is arranged in front of the SOA. During operation, the optical signal received by the optical receiver will be attenuated first by the VOA to prevent the SOA from entering the gain saturation state (due to the optical signal received by the light receiver being excessively large), and then the attenuated optical signal is amplified by the SOA. An optical receiving device further converts the optical signal amplified by the SOA into an electrical signal.

Chinese Patent Application No. 201410853664.2 filed under the title of “METHOD AND DEVICE FOR CONTROLLING OPTICAL RECEIVER, AND OPTICAL RECEIVER” discloses a method for controlling an optical receiver and the optical receiver. The optical receiver includes a VOA, a SOA, an optical receiving device, and a calculation controller. Conventionally, the VOA and the SOA are independently and hermetically packaged devices. Adding the VOA and the SOA to the receiver is usually applied to CFP2 and CFP optical modules, as the module has a large size, which is not conducive to miniaturization. The method for controlling the optical receiver disclosed in the above-mentioned patent application is to obtain and compare an output voltage of the optical receiving device, a voltage of the VOA, and an electric current of the SOA respectively with their initial values, and to determine whether or not to adjust the voltage of the VOA or the electric current of the SOA according to comparison results. Such a control method is cumbersome and complicated.

### SUMMARY OF THE DISCLOSURE

The objectives of the present disclosure are to provide an optical receiving assembly, a method for controlling the same, and an optical module, which have the advantages of small size, and the control is simple.

In order to achieve one aspect of the aforementioned objectives, one of the technical aspects adopted by the present disclosure is to provide an optical receiving assembly, which includes: an optical receiving port, an adjustable optical path deflection assembly, a semiconductor optical amplifier, an optical detector and a controller. An optical signal received by the optical receiving port is incident onto the semiconductor optical amplifier after the adjustable optical path deflection assembly adjusts a deflection angle of the optical signal, and the semiconductor optical amplifier amplifies and couples an incident optical signal to the optical detector, and the optical detector converts a received optical signal into an electrical signal and outputs the electrical signal. The controller controls the adjustable optical path deflection assembly according to an electrical signal strength output by the optical detector, so as to adjust a coupling efficiency of the optical signal coupled from the optical receiving port to the semiconductor optical amplifier, so that the electrical signal output by the optical detector maintains within a preset range. The adjustable optical path deflection assembly adjusts the coupling efficiency of the optical signal coupled from the optical receiving port to the semiconductor optical amplifier by adjusting a deflection angle of the optical signal.

In one of the possible or preferred embodiments, the adjustable optical path deflection assembly is a transmissive type deflection assembly.

In one of the possible or preferred embodiments, the adjustable optical path deflection assembly is a MEMS refractor, or the adjustable optical path deflection assembly includes a refraction prism with an adjustable refractive index, or the adjustable optical path deflection assembly includes a refraction prism and an angle adjustment mechanism, and the controller controls the angle adjustment mechanism to adjust an angle of the refraction prism.

In one of the possible or preferred embodiments, the adjustable optical path deflection assembly is a reflective type deflection assembly.

In one of the possible or preferred embodiments, the adjustable optical path deflection assembly is a MEMS reflection mirror, or the adjustable optical path deflection assembly includes a reflection mirror and an angle adjustment mechanism, and the controller controls the angle adjustment mechanism to adjust a deflection angle of the reflection mirror.

In one of the possible or preferred embodiments, the optical receiving assembly further includes: an optical path deflection unit. The optical path deflection unit is located in a light path between the optical receiving port and the adjustable optical path deflection assembly, or is located in a light path between the adjustable optical path deflection assembly and the semiconductor optical amplifiers. The optical path deflection unit is configured to deflect an optical signal received by the optical receiving port to the adjustable optical path deflection assembly, or to deflect an optical signal reflected by the adjustable optical path deflection assembly to the semiconductor optical amplifier.

In one of the possible or preferred embodiments, the optical path deflection unit is a reflection mirror or a refraction prism.

In one of the possible or preferred embodiments, the optical receiving assembly further includes: two optical path deflection units. The two optical path deflection units are respectively located in the light path in front of and behind the adjustable optical path deflection assembly. The two optical path deflection units are respectively configured to deflect an optical signal received by the optical receiving port to the adjustable optical path deflection assembly, and to deflect an optical signal reflected by the adjustable optical path deflection assembly to the semiconductor optical amplifier.

In one of the possible or preferred embodiments, the two optical path deflection units are two separate reflection mirrors or two refraction prisms respectively, or the two optical path deflection units are two reflection mirrors respectively arranged on a triangular prism.

In one of the possible or preferred embodiments, the optical receiving assembly further includes: a collimating lens group, a first coupling lens, a second coupling lens and a trans-impedance amplifier. The collimating lens group is located in a light path between the optical receiving port and the adjustable optical path deflection assembly. The first coupling lens is located in a light path between the adjustable optical path deflection assembly and the semiconductor optical amplifier and configured to couple optical signals into the semiconductor optical amplifier. The second coupling lens is located in a light path in front of the optical detector and configured to couple the optical signal amplified by the semiconductor optical amplifier into the optical detector. The trans-impedance amplifier is electrically connected to the optical detector and configured to amplify an electrical signal output by the optical detector.

In one of the possible or preferred embodiments, a combination of one, two or more of an optical isolator, an optical filter, a wave division multiplexer, and an optical path deflector is further provided between the semiconductor optical amplifier and the second coupling lens, and/or an optical isolator is further provided between the semiconductor optical amplifier and the adjustable optical path deflection assembly.

In one of the possible or preferred embodiments, the semiconductor optical amplifier comprises a semiconductor optical amplifier chip and a TEC, the semiconductor optical amplifier chip is arranged on the TEC through a substrate, and the controller controls the TEC to stabilize an operating temperature of the semiconductor optical amplifier chip.

In one of the possible or preferred embodiments, the optical receiving assembly further includes: a sealed box. An airtight cavity is provided inside the sealed box, the optical receiving port is arranged at one end of the sealed box and an electrical interface is provided at another end or one side of the sealed box. The electrical interface is electrically connected to an external circuit board, and the controller is arranged on the external circuit board. The adjustable optical path deflection assembly, the semiconductor optical amplifier and the optical detector are arranged in the airtight cavity.

In order to achieve one aspect of the aforementioned objectives, another one of the technical aspects adopted by the present disclosure is to provide an optical module, which includes a packaging housing and a circuit board arranged in the packaging housing. The optical module further includes any one of the optical receiving assemblies as mentioned above. The optical receiving assembly is arranged in the packaging housing and electrically connected to the circuit board.

In order to achieve one aspect of the aforementioned objectives, yet another one of the technical aspects adopted by the present disclosure is to provide a method for controlling an optical receiving assembly. The optical receiving assembly includes an adjustable optical path deflection assembly, a semiconductor optical amplifier and an optical detector. The method includes steps of: setting an operating voltage and an operating temperature of the semiconductor optical amplifier, and maintaining the operating voltage and the operating temperature at a voltage preset value and a temperature preset value, respectively; monitoring an electrical signal strength output by the optical detector, and determining whether the electrical signal strength is within a preset range; and when the electrical signal strength is within the preset range, maintaining a state of the adjustable optical path deflection assembly unchanged, and when the electrical signal strength is not within the preset range, controlling the adjustable optical path deflection assembly to adjust a deflection angle of an optical signal incident onto the semiconductor optical amplifier according to a change of the electrical signal strength, so as to adjust a coupling efficiency of the optical signal coupled into the semiconductor optical amplifier to make the electrical signal strength output by the optical detector maintaining within the preset range.

In one of the possible or preferred embodiments, a method for monitoring the electrical signal strength output by the optical detector is to monitor the electrical signal strength by detecting a received signal strength indication (RSSI) of a trans-impedance amplifier electrically connected to the optical detector.

In one of the possible or preferred embodiments, the voltage preset value and the temperature preset value are an optimal operating point of the semiconductor optical amplifier when a specific optical power is incident onto the semiconductor optical amplifier. The specific optical power is less than or equal to an optical power corresponding to a sensitivity point required by the optical receiving assembly, and the specific optical power is greater than or equal to an optical power corresponding to an optimal sensitivity point of the optical receiving assembly. The optical power corresponding to the sensitivity point required by the optical receiving assembly is greater than or equal to the optical power corresponding to the optimal sensitivity point of the optical receiving assembly.

In one of the possible or preferred embodiments, the preset range is the electrical signal strength that is monitored when the specific light power is incident onto the semiconductor optical amplifier.

The present disclosure provides the following benefits, a hermetic packaging mode is adopted in the present disclosure to package the adjustable optical path deflection assembly and the semiconductor optical amplifier chip in the optical receiving assembly, so as to effectively reduce the volume of an optical receiver. Such configuration facilitates the miniaturization of the optical module and is applicable to optical modules of QSFP series and OSFP models or those of the above size. A control method is simplified, such that fast and efficient control can be achieved with high sensitivity.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic structural diagram of an optical receiving assembly and a circuit board of an optical module according to the present disclosure;

FIG. 2 is a schematic diagram illustrating a structural principle of an optical receiving assembly according to Embodiment 1 of the present disclosure;

FIG. 3 is a schematic diagram illustrating a modified structural principle of the optical receiving assembly according to Embodiment 1 of the present disclosure;

FIG. 4 is a schematic diagram illustrating a structural principle of an optical receiving assembly according to Embodiment 2 of the present disclosure;

FIG. 5 is a schematic diagram illustrating a structural principle of an optical receiving assembly according to Embodiment 3 of the present disclosure;

FIG. 6 is a schematic diagram illustrating a structural principle of an optical receiving assembly according to Embodiment 4 of the present disclosure;

FIG. 7 is a schematic diagram illustrating a structural principle of an optical receiving assembly according to Embodiment 5 of the present disclosure;

FIG. 8 is a schematic diagram illustrating a structural principle of an optical receiving assembly according to Embodiment 6 of the present disclosure;

FIG. 9 is a schematic diagram illustrating a packaging structure of the optical receiving assembly according to Embodiment 6 of the present disclosure; and

FIG. 10 is a schematic exploded diagram of the packaging structure of the optical receiving assembly according to Embodiment 6 of the present disclosure.

### DETAILED DESCRIPTION OF THE EXEMPLARY EMBODIMENTS

The present disclosure is more particularly described in the following embodiments shown in the accompanying drawings. However, these embodiments are not used to limit the present disclosure. The modifications and variations on structural, method, or functional made by those skilled in the art according to these embodiments are covered by the present disclosure. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

In the drawings of the present disclosure, the sizes of certain structures or portions may be enlarged relative to other structures or portions for illustrative purposes, and thus are merely used for illustration of the basic structure of the subject matter of the present disclosure.

In addition, spatially relative terms (such as “over,” “above,” “under,” and “below”) in the present disclosure are used to conveniently describe a spatial relationship between one element/feature and another element/feature as shown in the drawings. These spatially relative terms are intended to include different orientations of a device in use or in operation other than the orientations illustrated in the drawings. For example, when the device in the drawing is turned over, elements described as below and/or under other elements or features would then be oriented above the other elements or features. Therefore, the exemplary term “below” encompasses both orientations of “above” and “below”. The device may also be otherwise oriented (rotated 90 degrees or at other orientations), and the spatially relative terms used herein is to be interpreted accordingly. When one element/layer is referred to as being disposed “above” or “connected to” another element/layer, said element/layer can be directly disposed above or connected to another element/layer, or a middle element/layer can be provided therebetween.

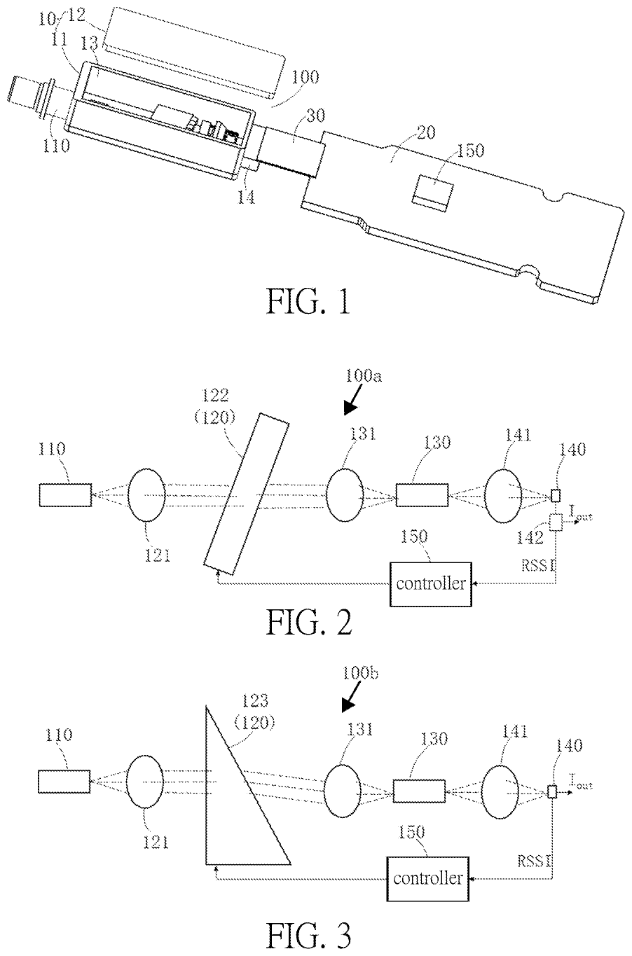

The present disclosure provides an optical module, which includes a packaging housing, and an optical receiving assembly 100 and a circuit board 20 that are disposed in the packaging housing. FIG. 1 is a schematic structural diagram of the optical receiving assembly 100 and the circuit board 20. The optical receiving assembly 100 includes a sealed box 10. The sealed box 10 includes a lower shell 11 and a cover plate 12, and the lower shell 11 and the cover plate 12 are sealed to form an airtight cavity 13. One end of the sealed box 10 is provided with an optical receiving port 110, and another end or one side of the sealed box 10 is provided with an electrical interface 14. The electrical interface 14 is electrically connected to the circuit board 20 of the optical module. In the present embodiment, the electrical interface 14 of the sealed box 10 is electrically connected to the circuit board 20 through a flexible printed circuit board (soft board) 30. In other embodiments, the electrical interface 14 of the sealed box 10 may also be electrically connected to the circuit board 20 by wire bonding, etc.

The optical receiving assembly 100 further includes an adjustable optical path deflection assembly, a semiconductor optical amplifier, and an optical detector which are arranged in the airtight cavity 13 of the sealed box 10, and a controller arranged on the circuit board 20 of the optical module. In other embodiments, the controller can also be arranged in the sealed box 10. In the present embodiment, the controller is a micro control unit (MCU). An optical signal received by the optical receiving port is incident onto the semiconductor optical amplifier after adjustment of a deflection angle by the adjustable optical path deflection assembly. The semiconductor optical amplifier amplifies and couples an incident optical signal to the optical detector. The optical detector converts a received optical signal into an electrical signal and then outputs the electrical signal. According to an electrical signal strength output by the optical detector, the controller controls the adjustable optical path deflection assembly to adjust a coupling efficiency of the optical signal coupled from the optical receiving port to the semiconductor optical amplifier, so that the electrical signal output by the optical detector is maintained within a preset range. Wherein the adjustable optical path deflection assembly adjusts the coupling efficiency of the optical signal coupled from the optical receiving port to the semiconductor optical amplifier by adjusting the deflection angle of the optical signal.

The present disclosure further provides a method for controlling the above-mentioned optical receiving assembly, which includes the following steps.

After starting, an operating voltage and an operating temperature of the semiconductor optical amplifier are set, and the operating voltage and the operating temperature are respectively maintained at a voltage preset value and a temperature preset value.

The electrical signal strength output by the optical detector is monitored, and whether or not the electrical signal strength is within a preset range is determined.

When the electrical signal strength is within the preset range, the state of the adjustable optical path deflection assembly is maintained to be unchanged. When the electrical signal strength is not within the preset range, the adjustable optical path deflection assembly is controlled to adjust the deflection angle of the optical signal according to the change of the electrical signal strength, so as to adjust the coupling efficiency of the optical signal coupled to the semiconductor optical amplifier to make the electrical signal strength output by the optical detector maintain within the preset range.

In the present embodiment, the method for monitoring the electrical signal strength output by the optical detector is to monitor the electrical signal strength by detecting a received signal strength indication (RSSI) of a trans-impedance amplifier which is electrically connected to the optical detector. The voltage preset value and the temperature preset value are an operating condition (the operating voltage and the operating temperature) of the semiconductor optical amplifier when a specific optical power is incident onto the semiconductor optical amplifier and a bit error rate of the optical receiving assembly is less than or equal to a bit error rate required by a communication system. Such an operating condition is also referred to as an optimal operating point. The specific optical power is less than or equal to an optical power corresponding to a sensitivity point required by the optical module, and is greater than or equal to an optical power corresponding to an optimal sensitivity point of the optical receiving assembly. The optical power corresponding to the sensitivity point required by the optical module is greater than or equal to the optical power corresponding to the optimal sensitivity point of the optical receiving assembly. In the present embodiment, the specific optical power is set as the optical power corresponding to the sensitivity point required by the optical module. The preset range is an electrical signal strength that is monitored when the specific optical power is incident onto the semiconductor optical amplifier. The sensitivity point required by the optical module refers to a minimal optical power value required to satisfy the bit error rate (such as an E-12 bit error rate) for the communication system. The optimal sensitivity point of the optical receiving assembly refers to a minimal optical power value required by the optical receiving assembly to achieve a specific bit error rate.

In the present embodiment, the controller monitors the electrical signal strength output by the optical detector, and controls the adjustable optical path deflection assembly to adjust the deflection angle of the optical signal according to the change of the monitored electrical signal strength, so as to adjust the coupling efficiency of the optical signal to the semiconductor optical amplifier. In this way, the optical power incident onto the semiconductor optical amplifier is stable at a lower point of the received optical strength (optical power) of the optical module, and the semiconductor optical amplifier keeps operating at the optimal operating point at the lower incident light (the specific optical power), so that the electrical signal strength output by the optical detector is maintained within the preset range to ensure the sensitivity performance of the optical module. After the optical receiving assembly is debugged, the preset range of the electrical signal strength and the operating condition (the operating temperature and the operating voltage, etc.) of the semiconductor optical amplifier are fixed, and the semiconductor optical amplifier is maintained at the optimal operating point at the specific optical power during operation, so that the sensitivity performance of the optical module is ensured by keeping the optical receiving assembly to operate between the optimal sensitivity point and the sensitivity point required by the optical module.

The operating performance of the semiconductor optical amplifier varies with the change of the optical power of the incident optical signal, the operating temperature, and the operating voltage. In such a control method, after the optical receiving assembly is debugged, the above-mentioned influencing factors of the semiconductor optical amplifier are all controlled at a fixed operating point, so that the semiconductor optical amplifier keep operating at the optimal operating point at a lower light incident point (the specific optical power) to ensure the sensitivity performance of a system (the optical receiving assembly or the optical module). That is, no matter how high the optical signal strength received by the optical receiving port is, the controller can control the adjustable optical path deflection assembly to adjust and change the deflection angle of the optical signal, so as to adjust the coupling efficiency of the optical signal to the semiconductor optical amplifier and maintain the optical signal incident onto the semiconductor optical amplifier at a lower optical power. At the same time, the operating temperature and the operating voltage of the semiconductor optical amplifier will be maintained at the optimal operating point at the lower optical power. The power change of the optical signal received by the optical receiving port will lead to the change of the optical power incident onto the semiconductor optical amplifier, and the power of the optical signal amplified by the semiconductor optical amplifier will also change, so that the power of the optical signal received by the optical detector also varies, which causes the electrical signal output by the optical detector to vary. The controller acquires the optical signal strength (power) received by the optical detector by monitoring the RSSI of the trans-impedance amplifier. When the optical signal strength received by the optical detector is detected to change, the controller will control the adjustable optical path deflection assembly to deflect an angle of the optical signal and adjust the angle of the optical signal incident onto a first coupling lens for changing the coupling efficiency of the optical signal coupled to the semiconductor optical amplifier. So as to maintain the optical signal coupled into the semiconductor optical amplifier at the specific power, to ensure the sensitivity performance of an optical receiving system.

In this control method, the operating temperature and the operating voltage of the semiconductor optical amplifier are kept constant, and only the change of the electrical signal strength output by the optical detector is monitored to feedback to control the adjustable optical path deflection assembly of a dimming system to deflect the angle of the optical signal. In this way, the optical signal strength incident onto the semiconductor optical amplifier can be maintained at a lower value, so as to ensure that the semiconductor optical amplifier operates at the optimal operating point. This control method is simple and convenient for achieving fast and efficient control, and has high sensitivity.

In the present disclosure, both the adjustable optical path deflection assembly and the semiconductor optical amplifier of the optical receiving assembly adopt chip-scale packaging. That is, chips of the adjustable optical path deflection assembly and the semiconductor optical amplifier are integrated and packaged in the sealed box of the optical receiving assembly, so that the volume of the optical receiving assembly can be effectively reduced. The sealed box of the optical receiving assembly can be 21 mm in length, 7 mm in width and 5 mm in height, or even smaller, and can be used in optical modules of QSFP series and OSFP models or those of the above size. The specific structure of the optical receiving assembly will be described in detail in the following embodiments.

### Embodiment 1

FIG. 2 is a schematic diagram illustrating a structural principle of an optical receiving assembly in Embodiment 1. An optical receiving assembly 100a includes an optical receiving port 110, an adjustable optical path deflection assembly 120, a semiconductor optical amplifier 130, an optical detector 140, and a controller 150. Wherein, the semiconductor optical amplifier 130 adopts a semiconductor optical amplifier chip (an SOA chip), and a first coupling lens 131 is provided between the adjustable optical path deflection assembly 120 and the semiconductor optical amplifier 130 for coupling the optical signal to the semiconductor optical amplifier 130. A second coupling lens 141 is further provided between the semiconductor optical amplifier 130 and the optical detector 140 for coupling the optical signal output by the semiconductor optical amplifier 130 into the optical detector 140. A collimating lens group 121 is further provided between the adjustable optical path deflection assembly 120 and the optical receiving port 110, and the collimating lens group 121 is configured to collimate the optical signal input to the optical receiving port 110 and then input the collimated optical signal to the adjustable optical path deflection assembly 120. The adjustable optical path deflection assembly 120 is configured to adjust an angle at which the optical signal is incident onto the first coupling lens 131, and the first coupling lens 131 couples the corresponding optical signal into the semiconductor optical amplifier 130. In the present embodiment, the collimating lens group 121 includes a single collimating lens. In other embodiments, the collimating lens group 12 may also include a combination of multiple lenses.

In the present embodiment, the adjustable optical path deflection assembly 120 is a transmissive type deflection assembly, and the controller 150 controls the transmissive type deflection assembly to adjust the angle at which the optical signal is incident onto the first coupling lens 131, thereby adjusting the optical signal strength coupled into the semiconductor optical amplifier 130. In the present embodiment, the transmissive type deflection assembly uses a MEMS refractor 122, and the controller 150 changes a deflection angle of a transmitted optical signal by controlling the operating voltage of the MEMS refractor 122. The MEMS refractor 122 is a refractor combined with a micro-electro-mechanical system (MEMS). During operation, the optical signal is input to the optical receiving port, and is incident onto the MEMS refractor 122 after being collimated by the collimating lens group 121. The optical signal is coupled into the semiconductor optical amplifier 130 by the first coupling lens 131 after passing through the MEMS refractor 122. The optical signal amplified by the semiconductor optical amplifier 130 is coupled into the optical detector 140 by the second coupling lens 141, and the optical detector 140 converts the received optical signal into an electrical signal and outputs the electrical signal, which is usually a current Iₒᵤₜ. In the present embodiment, the optical receiving assembly further includes a trans-impedance amplifier 142 for amplifying the electrical signal output by the optical detector 140, and then outputting the amplified electrical signal to an external circuit, such as a circuit board of an optical module.

An optical receiving assembly 100b shown in FIG. 3 is a modification of the optical receiving assembly in Embodiment 1. The difference is that the adjustable optical path deflection assembly 120 of the present embodiment includes a refraction prism 123 with an adjustable refractive index, such as a refraction prism made of a material having an electro-optic effect. The controller 150 changes the refractive index of the refraction prism 123 by controlling a voltage of the refraction prism 123, thereby changing the deflection angle of the transmitted optical signal. In this way, the angle at which the optical signal is incident onto the first coupling lens 131 can be changed. Afterwards, the coupling efficiency of the optical signal coupled to the semiconductor optical amplifier 130 is changed, so that the semiconductor optical amplifier 130 keeps operating at the optimal operating point. In other embodiments, a refraction prism made of a material having a magneto-optic effect or a thermo-optic effect may also be used as a transmissive type deflection element. The transmissive type deflection element may also include a refraction prism and an angle adjustment mechanism, and the controller adjusts an angle of the refraction prism by controlling the angle adjustment mechanism, so as to deflect the optical signal. The angle adjustment mechanism can be various commonly used mechanical structures.

Since a gain spectrum line of the semiconductor optical amplifier is relatively wide and the noise is relatively large, in the present embodiment, an optical filter (not shown in the figures) can be added in the light path between the semiconductor optical amplifier and the optical detector to filter out the noise, thereby improving the component performance.

### Embodiment 2

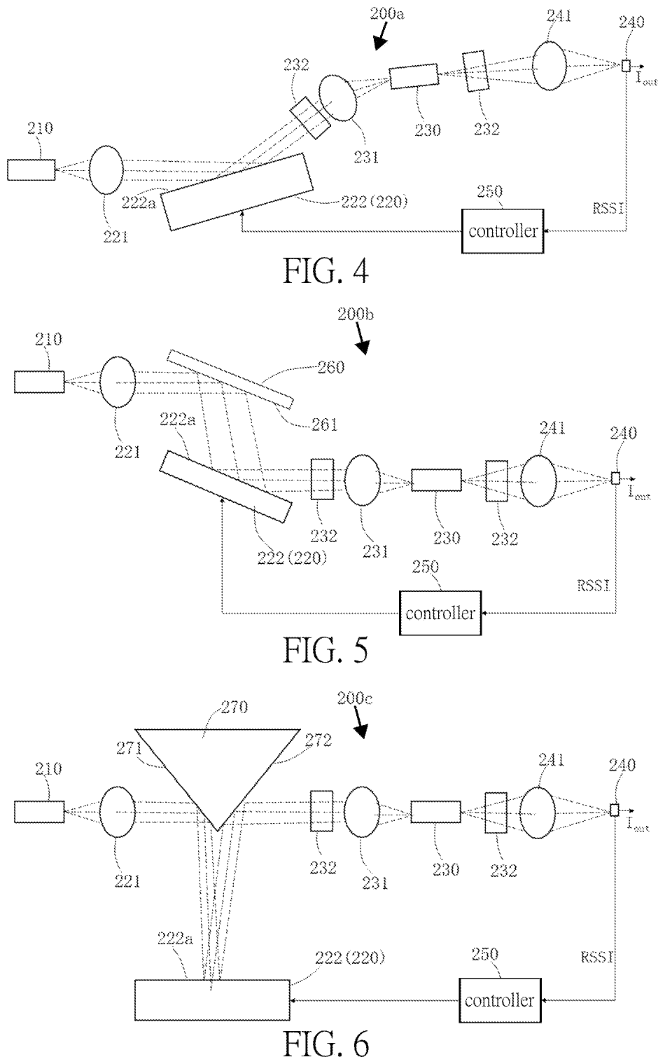

Similarly, an optical receiving assembly 200a shown in FIG. 4 includes an optical receiving port 210, an adjustable optical path deflection assembly 220, a first coupling lens 231, a semiconductor optical amplifier 230, a second coupling lens 241, an optical detector 240, and a controller 250. Wherein, a collimating lens 221 is further provided between the adjustable optical path deflection assembly 220 and the optical receiving port 210. Different from Embodiment 1, the adjustable optical path deflection assembly 220 of the present embodiment is a reflective type deflection assembly, and the reflective type deflection assembly includes a reflective surface 222a. The controller 250 controls the reflective type deflection assembly to adjust an angle at which the optical signal is incident onto the first coupling lens 231. In the present embodiment, the reflective type deflection assembly adopts a MEMS reflection mirror 222, and the MEMS reflection mirror 222 has the above-mentioned reflective surface 222a. In other embodiments, the reflective type deflection assembly may also include a reflection mirror and an angle adjustment mechanism. The reflection mirror has the above-mentioned reflective surface, and the controller adjusts an angle of the reflective surface by controlling the angle adjustment mechanism, so as to adjust the deflection angle of the optical signal. The angle adjustment mechanism can be various commonly used mechanical structures.

During operation, the optical signal is input to the optical receiving port 210, and is incident onto the MEMS reflection mirror 222 after being collimated by the collimating lens group 221. Then, the optical signal is reflected to the first coupling lens 231 by the MEMS reflection mirror 222, and is coupled into the semiconductor optical amplifier 230 by the first coupling lens 231. The optical signal amplified by the semiconductor optical amplifier 230 is coupled into the optical detector 240 by the second coupling lens 241, and the optical detector 240 converts the received optical signal into an electrical signal and outputs the electrical signal.

As shown in FIG. 4, in order to further improve the amplification performance of the semiconductor optical amplifier 230, an optical isolator 232 is provided in the light path in front of and behind the semiconductor optical amplifier 230 in the present embodiment, so as to prevent lights reflected by each optical end surface from entering the semiconductor optical amplifier 230 and affecting the performance of the semiconductor optical amplifier 230. The optical isolator 232 in front of the semiconductor optical amplifier 230 can be arranged in the light path in front of the first coupling lens 231, or in the light path between the first coupling lens 231 and the semiconductor optical amplifier 230. The optical isolator 232 behind the semiconductor optical amplifier 230 can be arranged in the light path between the semiconductor optical amplifier 230 and the second coupling lens 241, or can be arranged in the light path behind the second coupling lens 241.

### Embodiment 3

In an optical receiving assembly 200b shown in FIG. 5, the adjustable optical path deflection assembly 220 is also a reflective type deflection assembly, and the MEMS reflection mirror 222 is used. Different from Embodiment 2, the optical receiving assembly 200b of the present embodiment further includes an optical path deflection unit located on the light path between the optical receiving port 210 and the adjustable optical path deflection assembly 220. The optical path deflection unit is a reflection mirror 260. A reflective surface 261 of the reflection mirror 260 and the reflective surface 222a of the MEMS reflection mirror 222 are opposite and substantially parallel to each other. In other embodiments, the optical path deflection unit may also use a refraction prism or a prism having a reflective surface, such as a rectangular prism.

During operation, the optical signal is input to the optical receiving port 210, and is incident onto the reflective surface 261 of the reflection mirror 260 after being collimated by the collimating lens group 221. Then, the reflection mirror 260 reflects the optical signal to the reflective surface 222a of the MEMS reflection mirror 222. The optical signal is incident onto the first coupling lens 231 after being reflected by the reflective surface 222a of the MEMS reflection mirror 222, and is coupled into the semiconductor optical amplifier 230 by the first coupling lens 231. The optical signal amplified by the semiconductor optical amplifier 230 is coupled into the optical detector 240 by the second coupling lens 241, and the optical detector 240 converts the received optical signal into an electrical signal and outputs the electrical signal. In the present embodiment, the optical isolator 232 is also provided in the light path in front of and behind the semiconductor optical amplifier 230, so as to prevent lights reflected by each optical end surface from entering the semiconductor optical amplifier 230 and affecting the performance of the semiconductor optical amplifier 230.

In the aforementioned structure, the optical path deflection unit (the reflection mirror 260) is added between the optical receiving port 210 and the adjustable optical path deflection assembly 220 to adjust a position of the main light path such as the semiconductor optical amplifier 230 and the optical detector 240 in the sealed box, so that the main light path may not be on the same axis as the optical receiving port 210, and components and chips in the light path may be flexibly arranged. Naturally, in other embodiments, front or rear positions of the optical path deflection unit and the adjustable optical path deflection assembly 220 in the light path can be interchanged.

### Embodiment 4

In an optical receiving assembly 200c shown in FIG. 6, different from Embodiment 3, the optical receiving assembly 200c of the present embodiment further includes a triangular prism 270, and the triangular prism 270 includes a first reflection mirror 271 and a second reflection mirror 272. The first reflection mirror 271 and the second reflection mirror 272 are used as two optical path deflection units, and are respectively located in the light path in front of and behind the adjustable optical path deflection assembly 220. Wherein, the first reflection mirror 271 is located in the light path between the optical receiving port 210 and the adjustable optical path deflection assembly 220, and is used to reflect and deflect the optical signal onto the reflective surface 222a of the adjustable optical path deflection assembly 220. Then, the adjustable optical path deflection assembly 220 reflects the optical signal to the second reflection mirror 272, and the second reflection mirror 272 reflects and deflects the optical signal to the first coupling lens 231. In the present embodiment, the adjustable optical path deflection assembly 220 also uses the MEMS reflection mirror 222. In other embodiments, these two optical path deflection units may also use two mirrors that are independently arranged, or two refraction prisms that are independently arranged and through which a direction of the light path is deflected.

During operation, the optical signal is input to the optical receiving port 210, and is incident onto the first reflection mirror 271 after being collimated by the collimating lens group 221. The first reflection mirror 271 reflects the optical signal to the MEMS reflection mirror 222 (the adjustable optical path deflection assembly 220), and then the optical signal is incident onto the second reflection mirror 272 after being reflected by the MEMS reflection mirror 222. The second reflection mirror 272 reflects the optical signal to the first coupling lens 231, and the first coupling lens 231 couples the optical signal to the semiconductor optical amplifier 230. The optical signal amplified by the semiconductor optical amplifier 230 is coupled into the optical detector 240 by the second coupling lens 241, and the optical detector 240 converts the received optical signal into an electrical signal and outputs the electrical signal. In the present embodiment, the optical isolator 232 is also provided in the light path in front of and behind the semiconductor optical amplifier 230, so as to prevent lights reflected by each optical end surface from entering the semiconductor optical amplifier 230 and affecting the performance of the semiconductor optical amplifier 230.

The optical receiving assembly of the present embodiment is added with two optical path deflection units, which are respectively a first optical path deflection unit (a first reflection mirror) and a second optical path deflection unit (a second reflection mirror). After them deflecting the light path, the adjustable optical path deflection assembly (the MEMS reflection mirror) adjusts the deflection angle of the light path, so that other devices except the MEMS reflection mirror can be on the same axis. In this way, the structure is more compact.

In the present embodiment, the collimating lens group 221 includes a single collimating lens, and the single collimating lens is located on the light path between the optical receiving port 210 and the first optical path deflection unit. Naturally, the collimating lens group 221 may also include a combination of multiple lenses.

### Embodiment 5

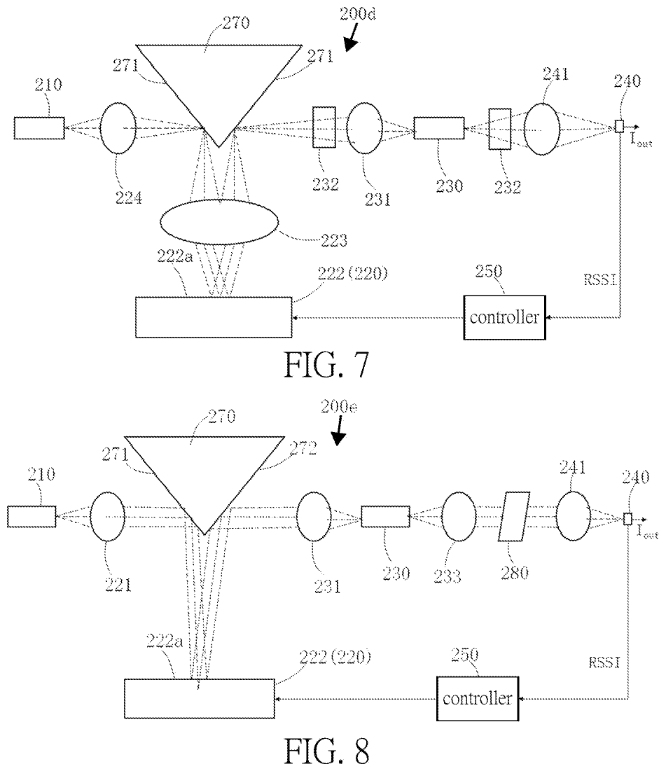

In an optical receiving assembly 200d as shown in FIG. 7, different from embodiment 4, in the present embodiment, a collimating lens group is located on the light path between the adjustable optical path deflection assembly 220 and the two optical path deflection units (the first reflection mirror 271 and the second reflection mirror 272). In the present embodiment, the collimating lens group includes a large collimating lens 223. The optical signal received by the optical receiving port 210 is incident onto the first optical path deflection unit (the first reflection mirror 271), and the optical signal reflected by the first optical path deflection unit (the first reflection mirror 272) is collimated by the large collimator lens 223 and incident onto the reflective surface 222a of the adjustable optical path deflection assembly 220 (the MEMS reflection mirror 222). After being reflected by the reflective surface 222a, the optical signal is once again transmitted through the large collimator lens 223, and is converged and incident to the second optical path deflection unit (the second reflection mirror 272). Then, the second optical path deflection unit (the second reflection mirror 272) reflects the optical signal to the first coupling lens 231, and the first coupling lens 231 couples the optical signal into the semiconductor optical amplifier 230. The optical signal amplified by the semiconductor optical amplifier 230 is coupled into the optical detector 240 by the second coupling lens 241, and is converted by the optical detector 240 into an electrical signal for output. In the present embodiment, a beam shaping element 224 is further provided between the optical receiving port 210 and the first optical path deflection unit (the first reflection mirror 271), and the beam shaping element 224 is used to reduce a light spot of the optical signal. In the present embodiment, the beam shaping element 224 adopts a focusing lens to narrow a beam of the optical signal and reduce a divergence angle of the optical signal. In other embodiments, the collimating lens group may also include two collimating lenses, which are respectively located in the light path between the first optical path deflection unit and the adjustable optical path deflection assembly 220 and the light path between the adjustable optical path deflection assembly 220 and the second optical path deflection assembly. The beam shaping element can also use other optical elements such as wedge prisms.

### Embodiment 6

In an optical receiving assembly 200e as shown in FIG. 8, different from embodiments 1 to 5, in the present embodiment, a plurality of wavelength channels are provided, a wave division multiplexer 280 is provided behind the semiconductor optical amplifier 230, and a quantity of the optical detector 240 is more than one. Specifically, the optical receiving assembly 200e of the present embodiment includes the optical receiving port 210, the adjustable optical path deflection assembly 220, the first coupling lens 231, the semiconductor optical amplifier 230, a collimating lens 233, the wave division multiplexer 280, the second coupling lens 241, the optical detectors 240, and the controller 250. In the present embodiment, the multiple optical detectors 240 are used to respectively receive single-channel optical signals demultiplexed and output by the wave division multiplexer 280. Correspondingly, a quantity of the second coupling lens 241 can be more than one, and the second coupling lenses 241 respectively correspond to the multiple optical detectors 240.

During operation, an optical signal containing multiple wavelengths is input to the optical receiving port 210. After the adjustable optical path deflection assembly 220 adjusts an angle at which the optical signal is incident onto the first coupling lens 231, the first coupling lens 231 couples the optical signal to the semiconductor optical amplifier 230. The optical signal amplified by the semiconductor optical amplifier 230 is collimated by the collimating lens 233, and is then incident in the wave division multiplexer 280. The wave division multiplexer 280 demultiplex the optical signal containing the multiple wavelengths into multiple single-channel optical signals, and then the single-channel optical signals are coupled into the corresponding optical detectors 240 through the second coupling lenses 241. Each of the optical detectors 240 converts the received single-channel optical signal into an electrical signal and outputs the electrical signal. In the present embodiment, an optical isolator (not shown in the figures) may also be provided in the light path in front of and/or behind the semiconductor optical amplifier 230, so as to prevent lights reflected by each optical end surface from entering the semiconductor optical amplifier 230 and affecting the performance of the semiconductor optical amplifier 230. The operating voltage and the operating temperature of the semiconductor optical amplifier are set at an operating point that takes all optical wavelengths into consideration. For example, in a 4-channel optical receiving assembly, the operating voltage and the operating temperature of the semiconductor optical amplifier are set at the optimal operating point at a lower incident light at the wavelength channel with a worst amplification performance. At the same time, other wavelength channels are ensured to be less than a saturation point. During operation, the controller simultaneously monitors the electrical signal strength output by each optical detector to ensure that the electrical signal strength output by each optical detector is maintained within their respective preset range, so that the sensitivity performance of each channel can be ensured.

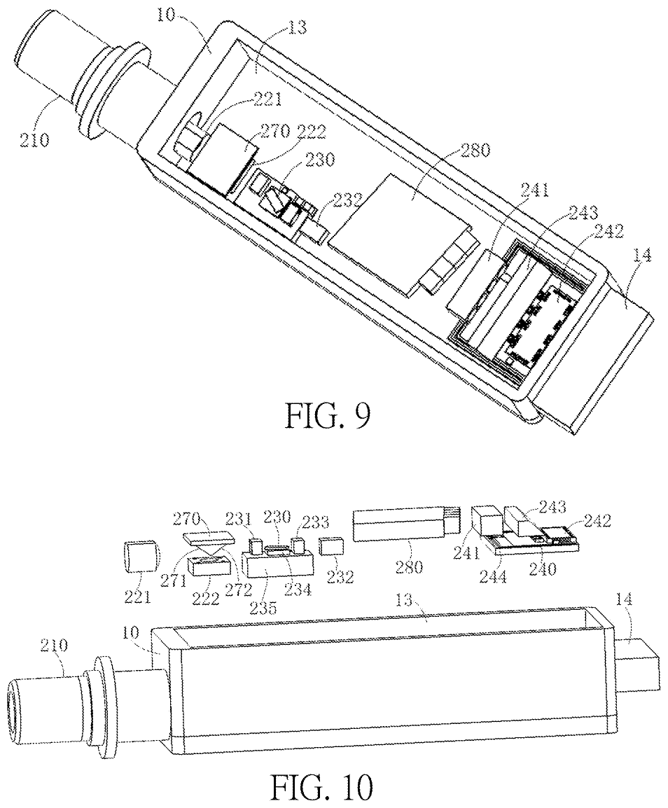

Specifically, FIGS. 9 and 10 illustrate a packaging structure of the optical receiving assembly, and the packaging structure includes the sealed box 10. For clarity, a cover plate of the sealed box 10 is omitted in the figures. The sealed box 10 has the airtight cavity 13, one end of the sealed box 10 is provided with the optical receiving port 210, and another end or one side of the sealed box 10 is provided with the electrical interface 14. The electrical interface 14 is used to be electrically connected to the circuit board of theoptical module. The adjustable optical path deflection assembly 220 (the MEMS reflection mirror 222), the first coupling lens 231, the semiconductor optical amplifier 230, the collimating lens 233, the wave division multiplexer 280, the second coupling lens 241, and the optical detector 240 are sequentially provided in the airtight cavity 13 of the sealed box 10. The controller of the optical receiving assembly is arranged on the circuit board of the optical module.

The collimating lens group 221 is further provided between the MEMS reflection mirror 222 and the optical receiving port 210, a triangular prism 270 is provided above the MEMS reflection mirror 222, and the triangular prism 270 includes the first reflection mirror 271 and the second reflection mirror 272. The first reflection mirror 271 is located in the light path between the collimating lens group 221 and the MEMS reflection mirror 222, and the second reflection mirror 272 is located in the light path between the MEMS reflection mirror 222 and the first coupling lens 231. The semiconductor optical amplifier 230 adopts a semiconductor optical amplifier chip (an SOA chip), which is arranged on TEC (a thermo-electric cooler) 235 through a substrate 234. By controlling the operation of the TEC 235, the controller is able to keep the operating temperature of the semiconductor optical amplifier 230 stable at the optimal operating point. In the present embodiment, the first coupling lens 231 and the collimating lens 233 are also placed on the TEC 235, and an optical isolator 232 is further provided in the light path between the collimating lens 233 and the wave division multiplexer 280, so as to prevent lights reflected by each optical end surface from entering the semiconductor optical amplifier 230 and affecting the performance of the semiconductor optical amplifier 230. The optical detector 240 is a surface-receiving photodiode (PD), in which a normal of an optical receiving surface is perpendicular to a main optical axis of the optical receiving assembly, and a right-angle prism 243 is further provided behind the second coupling lens 241 to reflect the optical signal of each channel to each optical detector 240. The optical detector 240 is arranged on a conductive substrate 244, and a trans-impedance amplifier 242 is further provided on the conductive substrate 244. After the electrical signal output by the optical detector 240 is amplified by the transimpedance amplifier 242, the amplified electrical signal is transmitted to the electrical interface 14 of the sealed box 10 through the conductive substrate 244, and is then transmitted to the circuit board of the optical module through the electrical interface 14.

For the packaging of Embodiments 1 to 3, reference can be made to the above-mentioned packaging structure of the optical receiving assembly. The packaging structure has a small size, and its dimensions can be 20.35 mm in length, 6.5 mm in width, and 4.5 mm in height, or even smaller. Hence, such a packaging structure can be used in optical modules of QSFP series and OSFP models or those of the above size.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An optical receiving assembly, comprising: an optical receiving port, an adjustable optical path deflection assembly, a semiconductor optical amplifier, an optical detector, and a controller, wherein an optical signal received by the optical receiving port is incident onto the semiconductor optical amplifier through the adjustable optical path deflection assembly, the semiconductor optical amplifier amplifies and couples the incident optical signal to the optical detector, and the optical detector converts the received optical signal into an electrical signal and outputs the electrical signal;
wherein the controller controls the adjustable optical path deflection assembly according to an electrical signal strength output by the optical detector, so as to adjust a coupling efficiency of the optical signal coupled from the optical receiving port to the semiconductor optical amplifier and maintain the electrical signal output by the optical detector within a preset range;
wherein the adjustable optical path deflection assembly adjusts the coupling efficiency of the optical signal coupled from the optical receiving port to the semiconductor optical amplifier by adjusting a deflection angle of the optical signal.

2. The optical receiving assembly according to claim 1, wherein the adjustable optical path deflection assembly is a transmissive type deflection assembly.

3. The optical receiving assembly according to claim 2, wherein the adjustable optical path deflection assembly is a MEMS refractor, or
the adjustable optical path deflection assembly includes a refraction prism with an adjustable refractive index, or
the adjustable optical path deflection assembly includes a refraction prism and an angle adjustment mechanism, and the controller controls the angle adjustment mechanism to adjust an angle of the refraction prism.

4. The optical receiving assembly according to claim 1, wherein the adjustable optical path deflection assembly is a reflective type deflection assembly.

5. The optical receiving assembly according to claim 4, wherein the adjustable optical path deflection assembly is a MEMS reflection mirror, or
the adjustable optical path deflection assembly includes a reflection mirror and an angle adjustment mechanism, and the controller controls the angle adjustment mechanism to adjust a deflection angle of the reflection mirror.

6. The optical receiving assembly according to claim 4, further comprising: an optical path deflection unit, wherein the optical path deflection unit is located in a light path between the optical receiving port and the adjustable optical path deflection assembly, or is located in a light path between the adjustable optical path deflection assembly and the semiconductor optical amplifier;
wherein the optical path deflection unit is configured to deflect the optical signal received by the optical receiving port to the adjustable optical path deflection assembly, or to deflect an optical signal reflected by the adjustable optical path deflection assembly to the semiconductor optical amplifier.

7. The optical receiving assembly according to claim 6, wherein the optical path deflection unit is a reflection mirror or a refraction prism.

8. The optical receiving assembly according to claim 4, further comprising: two optical path deflection units, wherein the two optical path deflection units are respectively located in the light path in front of and behind the adjustable optical path deflection assembly;
wherein the two optical path deflection units are respectively configured to deflect the optical signal received by the optical receiving port to the adjustable optical path deflection assembly, and to deflect an optical signal reflected by the adjustable optical path deflection assembly to the semiconductor optical amplifier.

9. The optical receiving assembly according to claim 8, wherein the two optical path deflection units are two separate reflection mirrors or two refraction prisms respectively, or the two optical path deflection units are two reflection mirrors respectively arranged on a triangular prism.

10. The optical receiving assembly according to claim 1, further comprising: a collimating lens group, a first coupling lens, a second coupling lens, and a trans-impedance amplifier,
wherein the collimating lens group is located in a light path between the optical receiving port and the adjustable optical path deflection assembly; wherein the first coupling lens is located in a light path between the adjustable optical path deflection assembly and the semiconductor optical amplifier, and is configured to couple the optical signal into the semiconductor optical amplifier;
wherein the second coupling lens is located in a light path in front of the optical detector, and is configured to couple the optical signal amplified by the semiconductor optical amplifier into the optical detector;
wherein the trans-impedance amplifier is electrically connected to the optical detector, and is configured to amplify the electrical signal output by the optical detector.

11. The optical receiving assembly according to claim 10, wherein a combination of one, two, or more of an optical isolator, an optical filter, a wave division multiplexer, and an optical path deflector are further provided between the semiconductor optical amplifier and the second coupling lens, and/or
an optical isolator is further provided between the semiconductor optical amplifier and the adjustable optical path deflection assembly.

12. The optical receiving assembly according to claim 1, wherein the semiconductor optical amplifier includes a semiconductor optical amplifier chip and a TEC (thermoelectric cooler), the semiconductor optical amplifier chip is arranged on the TEC through a substrate, and the controller controls the TEC to stabilize an operating temperature of the semiconductor optical amplifier chip.

13. The optical receiving assembly according to claim 1, further comprising: a sealed box,
wherein an airtight cavity is formed inside the sealed box, the optical receiving port is arranged at one end of the sealed box, and an electrical interface is provided at another end or one side of the sealed box; wherein the electrical interface is electrically connected to an external circuit board, and the controller is arranged on the external circuit board; wherein the adjustable optical path deflection assembly, the semiconductor optical amplifier, and the optical detector are arranged in the airtight cavity.

14. An optical module, comprising: a packaging housing and a circuit board arranged in the packaging housing, wherein the optical module further comprises the optical receiving assembly as claimed in claim 1, and the optical receiving assembly is arranged in the packaging housing and electrically connected to the circuit board.

15. A method for controlling an optical receiving assembly, wherein the optical receiving assembly includes an adjustable optical path deflection assembly, a semiconductor optical amplifier, and an optical detector, the method comprising steps of:
setting an operating voltage and an operating temperature of the semiconductor optical amplifier, and maintaining the operating voltage and the operating temperature respectively at a voltage preset value and a temperature preset value;
monitoring an electrical signal strength output by the optical detector, and determining whether or not the electrical signal strength is within a preset range; and
when the electrical signal strength is within the preset range, maintaining a state of the adjustable optical path deflection assembly to be unchanged, and, when the electrical signal strength is not within the preset range, controlling the adjustable optical path deflection assembly to adjust a deflection angle of an optical signal incident onto the semiconductor optical amplifier according to a change of the electrical signal strength, so as to adjust a coupling efficiency of the optical signal coupled into the semiconductor optical amplifier to make the electrical signal strength output by the optical detector maintaining within the preset range.

16. The method according to claim 15, wherein, in the step of monitoring the electrical signal strength output by the optical detector, the electrical signal strength is monitored by detecting a received signal strength indication (RSSI) of a trans-impedance amplifier that is electrically connected to the optical detector.

17. The method according to claim 15, wherein the voltage preset value and the temperature preset value are an optimal operating point of the semiconductor optical amplifier when a specific optical power is incident onto the semiconductor optical amplifier;
wherein the specific optical power is less than or equal to an optical power corresponding to a sensitivity point required by the optical receiving assembly, and the specific optical power is greater than or equal to an optical power corresponding to an optimal sensitivity point of the optical receiving assembly;
wherein the optical power corresponding to the sensitivity point required by the optical receiving assembly is greater than or equal to the optical power corresponding to the optimal sensitivity point of the optical receiving assembly.

18. The method according to claim 17, wherein the preset range is the electrical signal strength that is monitored when the specific optical power is incident onto the semiconductor optical amplifier.
